(19) United States
(12) Patent Application Publication
(10) Pub. No.: US 2002/0073091 A1
(43) Pub. Date: Jun. 13, 2002

(54) XML to object translation

(76) Inventors: Sandeep Jain, Belmont, CA (US); Sudheer Thakur, Belmont, CA (US)

Correspondence Address: Hickman Palermo Truong & Becker LLP, 1600 Willow Street, San Jose, CA, 95125-5106, US

(21) Appl. No.: 09/755,501

(22) Filed: Jan. 5, 2001

Related U.S. Application Data
(60) Provisional application No. 60/175,138, filed on Jan. 7, 2000.

(51) Int. Cl. G06F 7/00

(52) U.S. Cl. 707/100

(57) ABSTRACT

Techniques are provided for accessing data stored in XML documents using objects defined in object-oriented languages, such as Java. In one embodiment, a translation tool identifies the data nodes in an XML DTD associated with an XML document. The translation tool converts each of the identified nodes to a corresponding Java class in which a top-level data node in the XML DTD corresponds to a top-level Java class. From the Java classes and data in the XML document, a Java object is instantiated. The Java object thus can be used to advantageously access the data in the XML document in the Java language domain.

### FIELD OF THE INVENTION

The present invention relates generally to computer languages, and, more specifically, to translating an XML document to an object in an object-oriented language so that content of the XML document can be programmatically accessed.

### BACKGROUND OF THE INVENTION

XML or extensible Markup language is a language designed specifically for documents that contain structured information. Structured information contains both content and some indication of what role that content plays. The content may be, for example, words, pictures, etc. A document in the XML context refers not only to traditional documents, but also to other XML “data formats,” which include vector graphics, mathematical equations, object meta-data, and other kinds of structured information.

A Document Type Definition file (“DTD”) associated with an XML document defines how the mark up tags within the document should be interpreted by the application presenting the document. The HTML specification that defines how Web pages should be displayed by Web browsers is one example of a DTD.

XML does not provide for a common structure of access methods/utilities, which makes it difficult to use an XML document. Traditional access methods of an XML document require a utility to re-parse the XML document each time an element is accessed. Depending on the quantity of accessed elements and the size of the XML document, this can be a very expensive operation.

These access utilities are often referred to as “tree walkers,” because the need to navigate each level of the hierarchy until the correct node is found. Programmatically, this may be represented by a function call similar to the following:

resortXML.XMLDocument.documentElement.childNotes:item(1).test

The above code includes a lot of statically defined information to retrieve the value of a particular node. Should the structure of the XML document change, the code to retrieve the individual node element would have to change as well, illustrating the inherently problematic scenario above.

Through much effort, the information may be retrieved from the native XML document, but it does not work well with an Object Oriented programming language, such as Java. Specifically, Java is a general purpose “object-oriented” programming language. Java source code files are compiled into a format called “bytecode,” which can then be executed by a Java interpreter. Compiled Java code can run on most computers because Java interpreters and runtime environments, known as Java Virtual Machines (VMs), exist for most operating systems, including UNIX, the Macintosh OS, and Windows. Bytecode can also be converted directly into machine language instructions. In the Java language (or other object-oriented programming language) a “class” defines all common properties of the objects that belong to the class.

During programming, an object is instantiated from a class. Once an object is instantiated, accessing data related to the object is relatively simple because an object is a self-contained entity that consists of both data and procedures (or methods) to manipulate the data.

In view of the deficiencies of XML and the benefits of the Java language, there is a need for converting documents in the XML domain to the Java language domain so that benefits of the Java language may be utilized for XML documents.

### SUMMARY OF THE INVENTION

Techniques are disclosed for converting an XML document to an object in an object-oriented language, thereby providing a structured, programmatic, consistent, powerful, and in-memory method for accessing the data in the XML document. While the present invention is not limited to any particular object-oriented language, details of the invention are described herein for embodiments in which Java is the target object-oriented language.

In one embodiment, a translation tool converts an XML DTD associated with the XML document to Java classes from which a Java object corresponding to the XML document is instantiated. As the Java classes are created, the access utilities of the DTD become the accessor methods in the Java classes. Consequently, interfacing the XML document with the Java-based environments is more flexible and working with the content of the XML document is more efficient.

In accordance with one embodiment, Java classes are created and written to different files using the translation tool. The Java class files are then compiled to provide computer codes, which, in turns, are integrated into an executable Java program. When the executable Java program is run, various objects including the object corresponding to the XML document are instantiated.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows elements that are used in a technique for converting an XML document to a Java object, in accordance with one embodiment of the invention;

FIG. 2 shows the content of an XML DTD of FIG. 1;

FIG. 3 shows the content of an XML document associated with the XML DTD of FIG. 2;

FIGS. 4A-4E shows the content of a Java file having an Address class;

FIGS. 4F-4G show the content of a Java file having a Street class;

FIG. 4H-41 show the content of a Java file having a City class;

FIGS. 4J-4K show the content of a Java file having a State class;

FIGS. 4L-4M shows the content of a Java file having a Zip class;

FIGS. 40-4P shows the content of a Java file having a County class;

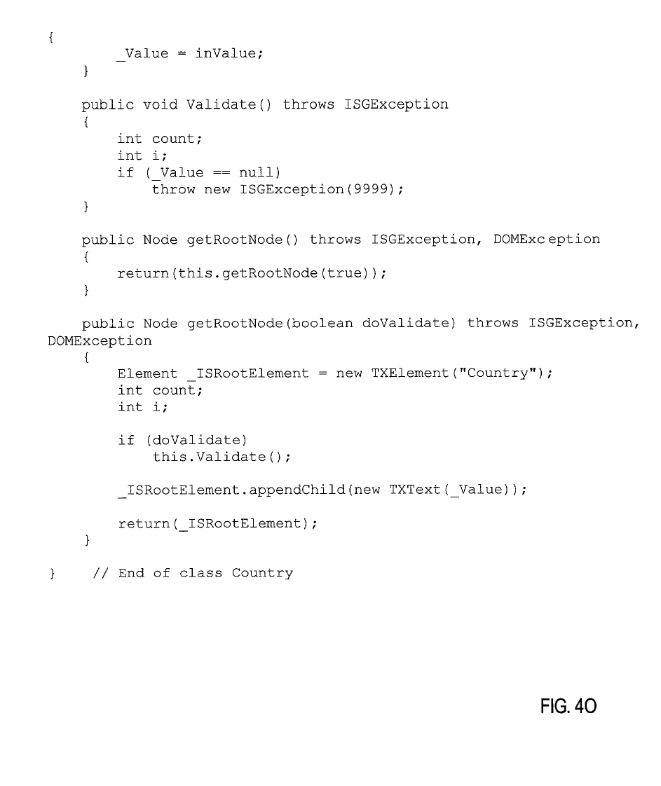

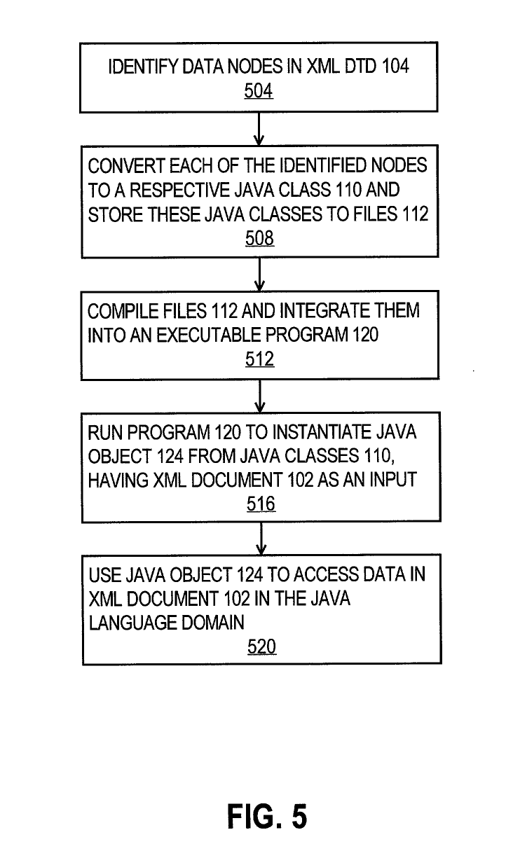

FIG. 5 is a flowchart illustrating a method for converting an XML document to a Java object;

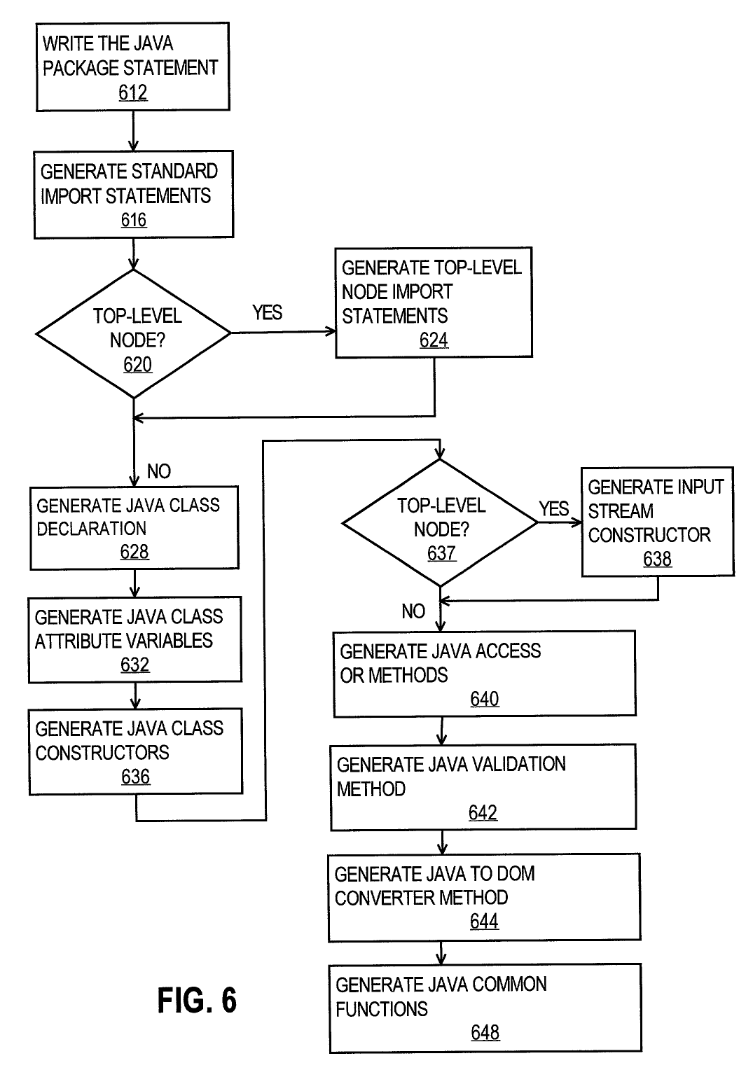

FIG. 6 is a flowchart illustrating a method for creating a Java class in accordance with FIG. 5; and

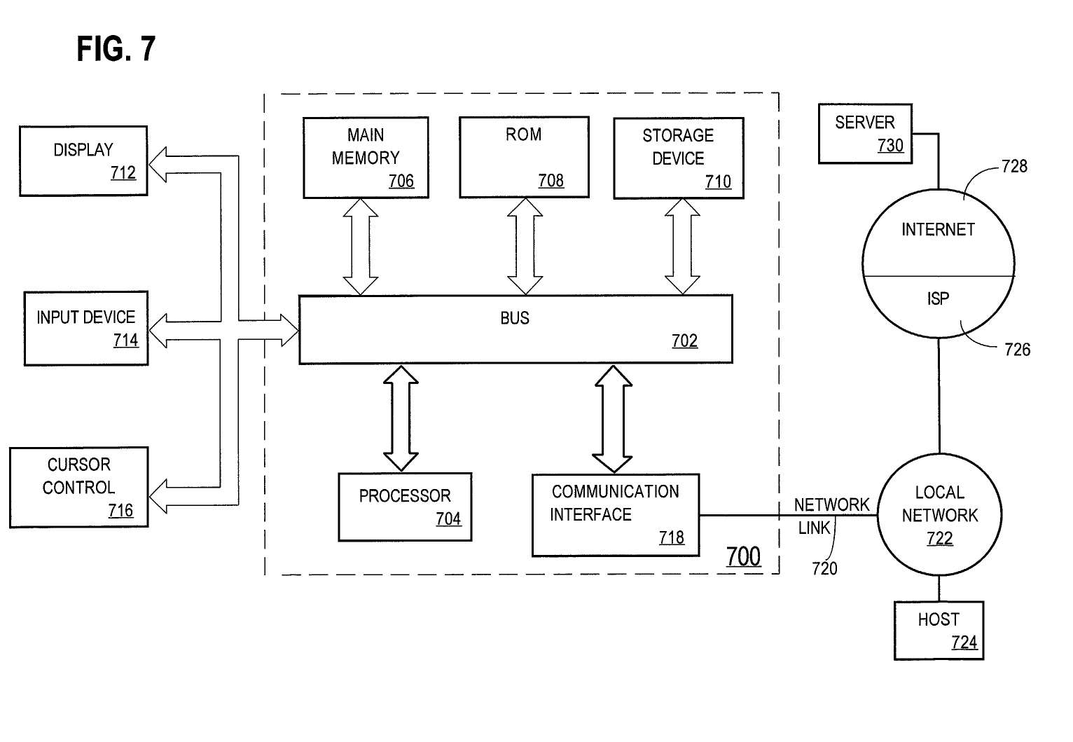

FIG. 7 shows a computer upon which an embodiment of the invention may be implemented.

### DETAILED DESCRIPTION OF THE PREFERRED EMBODIMENT

Techniques are provided for converting the content of an XML document to a Java object, which provides a consistent, powerful, and in-memory method for accessing the data in the XML document. Consequently, interfacing the XML document with the Java-based environments is more flexible and working with the document content is more efficient.

### FUNCTIONAL OVERVIEW

As mentioned above, a translation tool is provided for converting an XML DTD associated with the XML document to Java classes from which a Java object corresponding to the XML document is instantiated. In accordance with one embodiment, the translation tool first uses a parser to read the structure of the XML DTD and thus identifies all nodes in the XML DTD. For each of the identified nodes in the XML DTD, the translation tool creates a corresponding Java class and writes this Java class to a respective file. For each of the created Java classes, the translation tool initially generates a package statement. The translation tool then generates the standard import statements.

If a node in the XML DTD that is being converted is a top-level node, then the translation tool additionally generates the top-level-node import statements. The translation tool continues to generate the Java class declaration header, the Java class attribute variables, and the Java class constructors. The translation tool also generates the accessor methods to access the Java classes and individual node attributes. Finally, the translation tool generates the common Java class functions, which are methods to retrieve information about the overall messages as defined by the XML DTD. The translation tool also generates the appropriate Java syntaxes and comments.

### XML DTDS

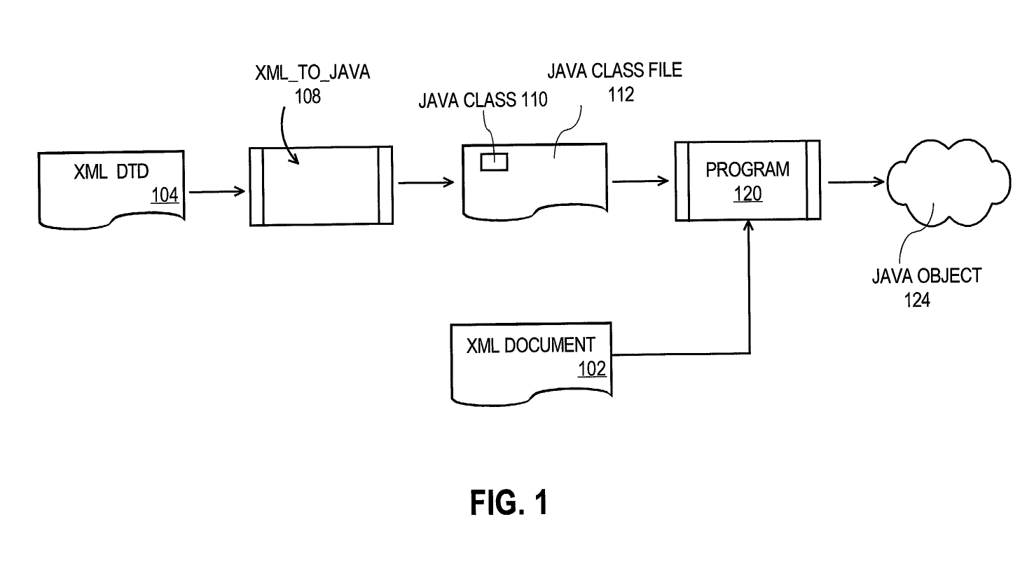

FIG. 1 shows elements that are used in a technique for converting an XML document 102 to a Java object 124, in accordance with one embodiment of the invention. In the XML domain, each XML document 102 is associated with an XML DTD 104. XML_to_Java translation tool 108 is used to convert an XML DTD 104 to Java classes 110 and stores each of these classes 110 in a respective file 112. Those skilled in the art will recognize that one Java class 110 is stored in one file 112 to practice modular programming. However, depending on the implementation, all Java classes 110 may be stored in one file 112 or various files 112 without departing from the scope of the various embodiments of the invention. The invention is not limited to how the classes 110 are stored in files 112. Each of the Java files 112 contains a Java class that is written in the Java language. The Java files 112 are then compiled to bytecode, which are integrated (or “linked”) into an executable Java program 120 that takes XML document 102 as a parameter to instantiate Java classes 110 to Java object 124. As Java object 124 is instantiated, its data is in memory and is thus easy to use.

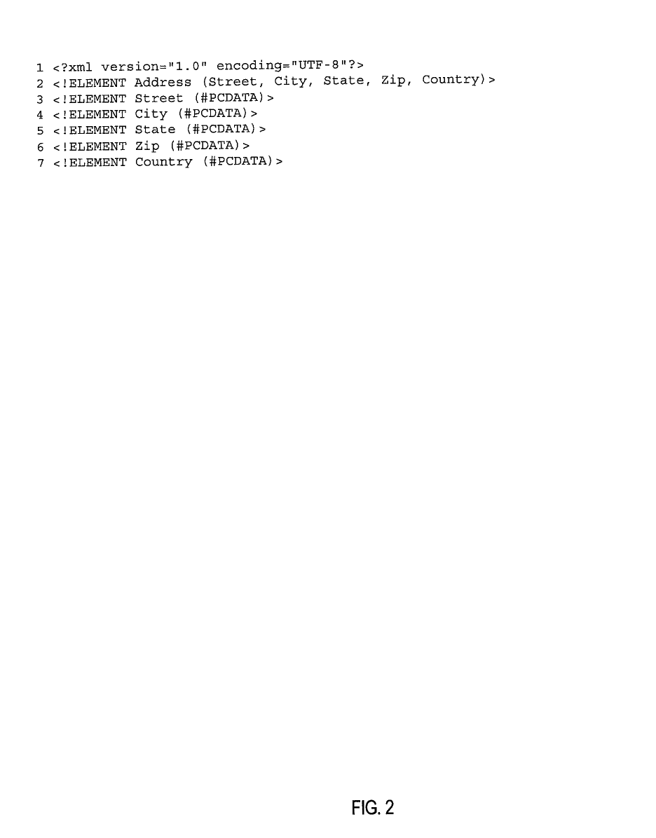

FIG. 2 shows the content of an XML DTD 104 that defines a document type entitled “DTD Address”, which shall be used herein as an exemplary XML DTD to describe embodiments of the invention. Line I shows miscellaneous information regarding DTD Address, including, for example, the version, the encoding scheme, etc. XML DTDs include a top-level node that may be formed by one or more child nodes. The child nodes usually contain information specific to the top-level node. In this example, line 2 shows Address as a top-level node, which comprises Street, City, State, Zip, and Country, as child nodes. Each of the child nodes Street, City, State, Zip, and Country is defined on lines 3-7 respectively.

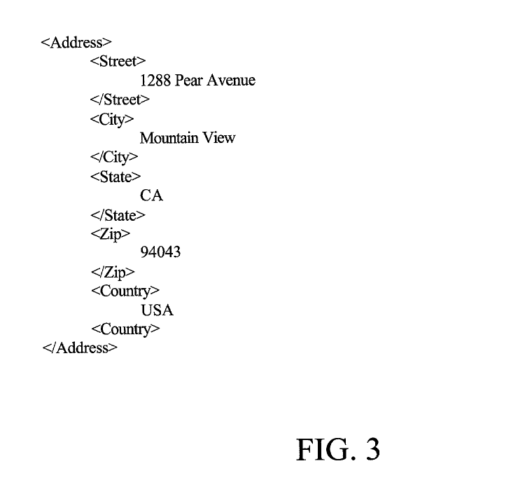

FIG. 3 shows the content of an exemplary XML document 102 having XML Address associated with the DTD Address in FIG. 2. XML document 102 provides the actual data for each of the XML DTD nodes. For example, in this FIG. 3, the Street node has a value of “1288 Pear Ave.”, the City node has a value of “Mountain View”, the State node has a value of “CA”, the Zip node has a value of “94043”, and the Country node has a value of “USA”.

### GENERATED JAVA CLASSES

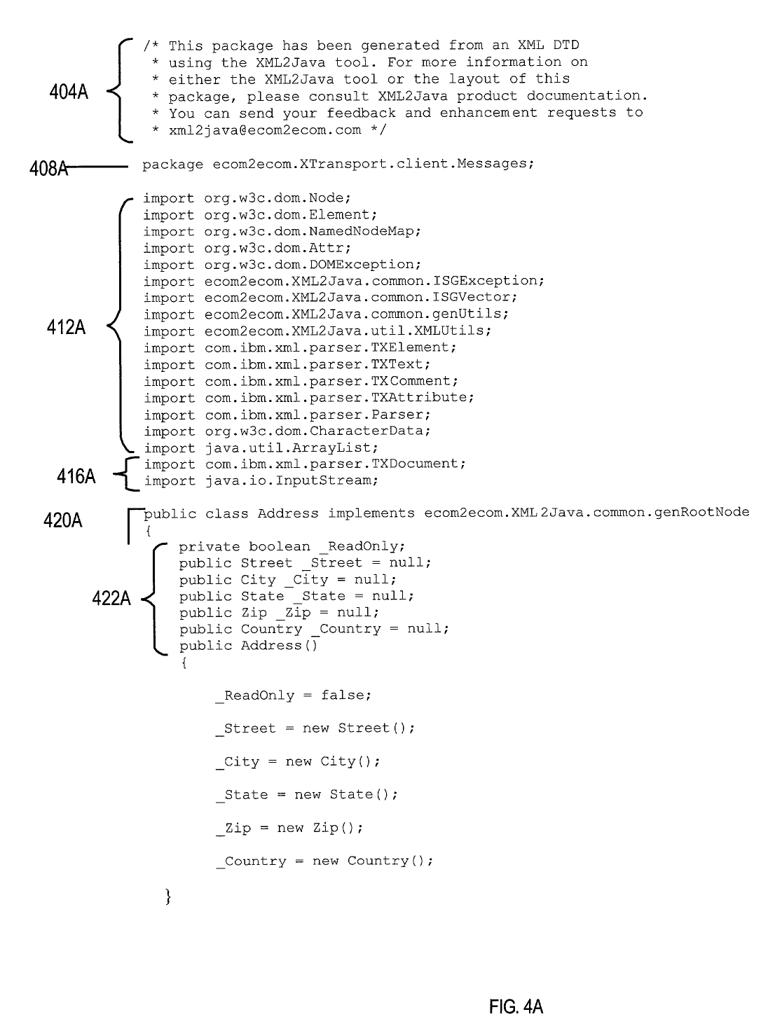

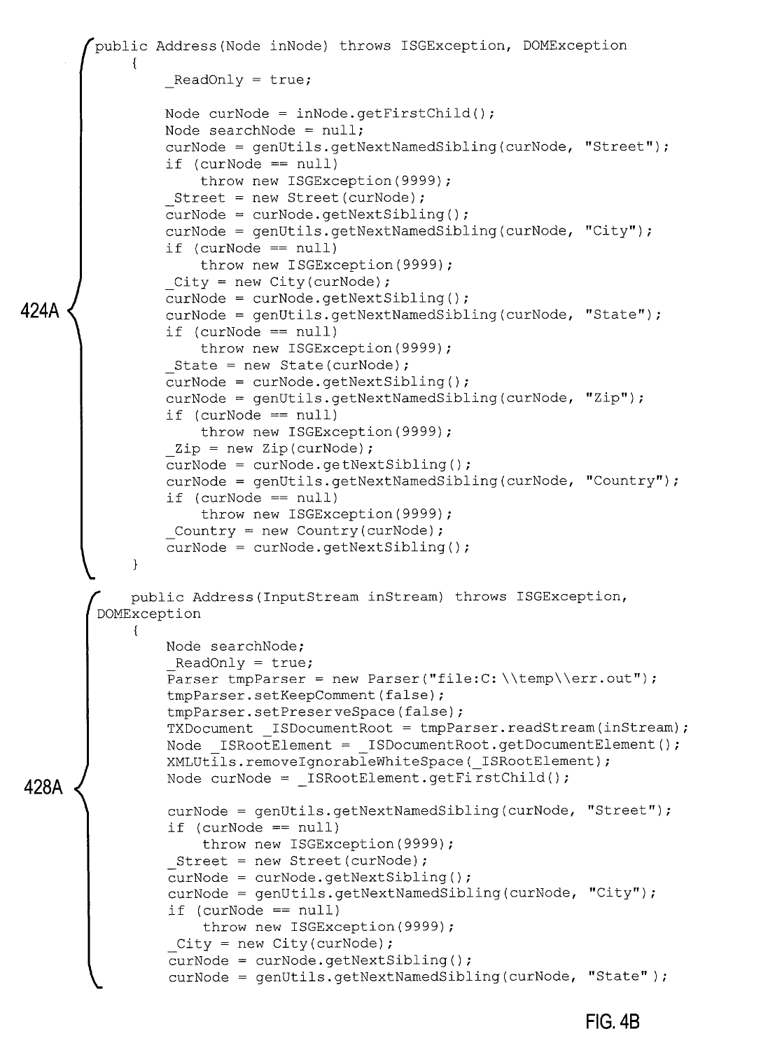

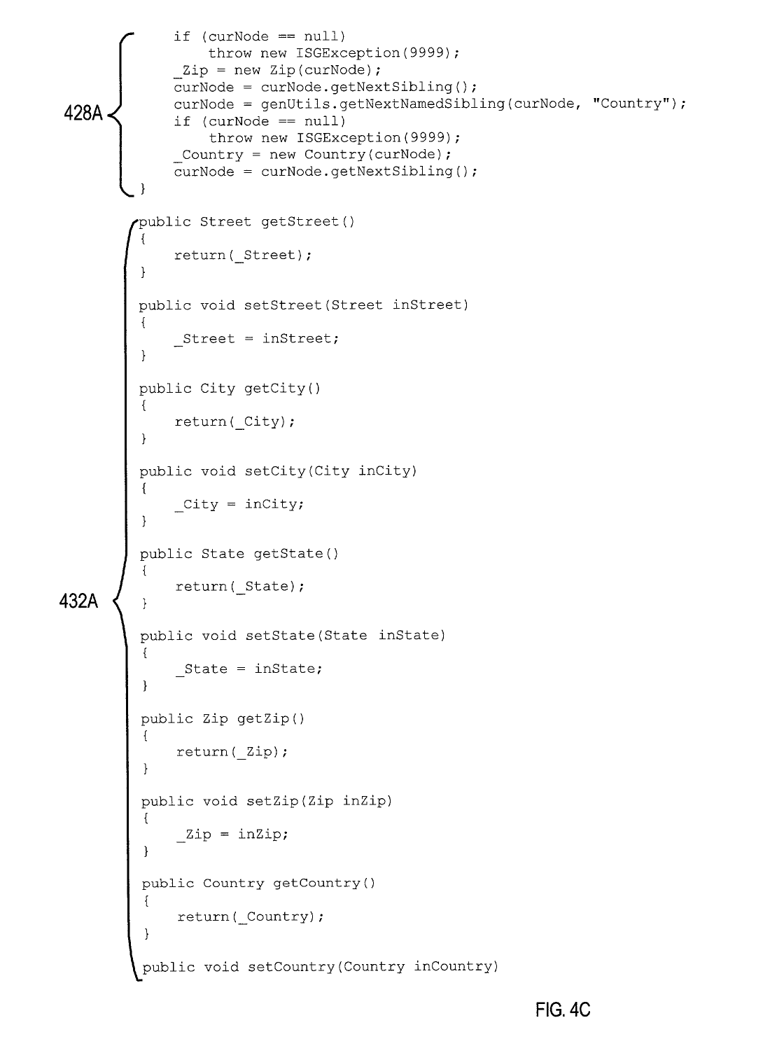

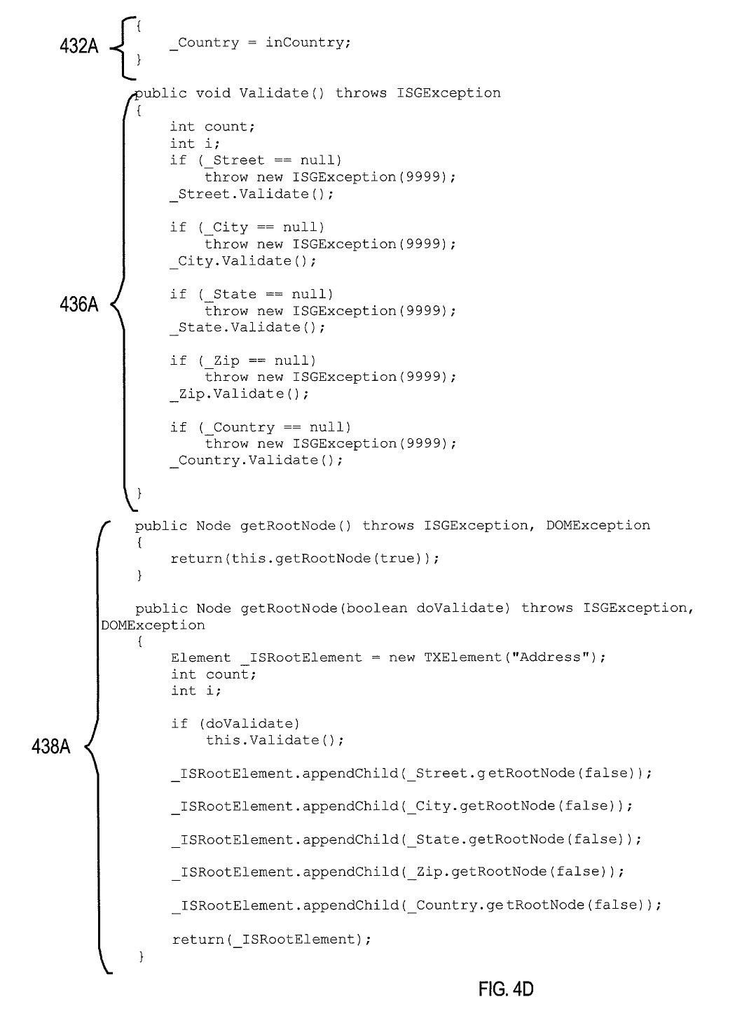

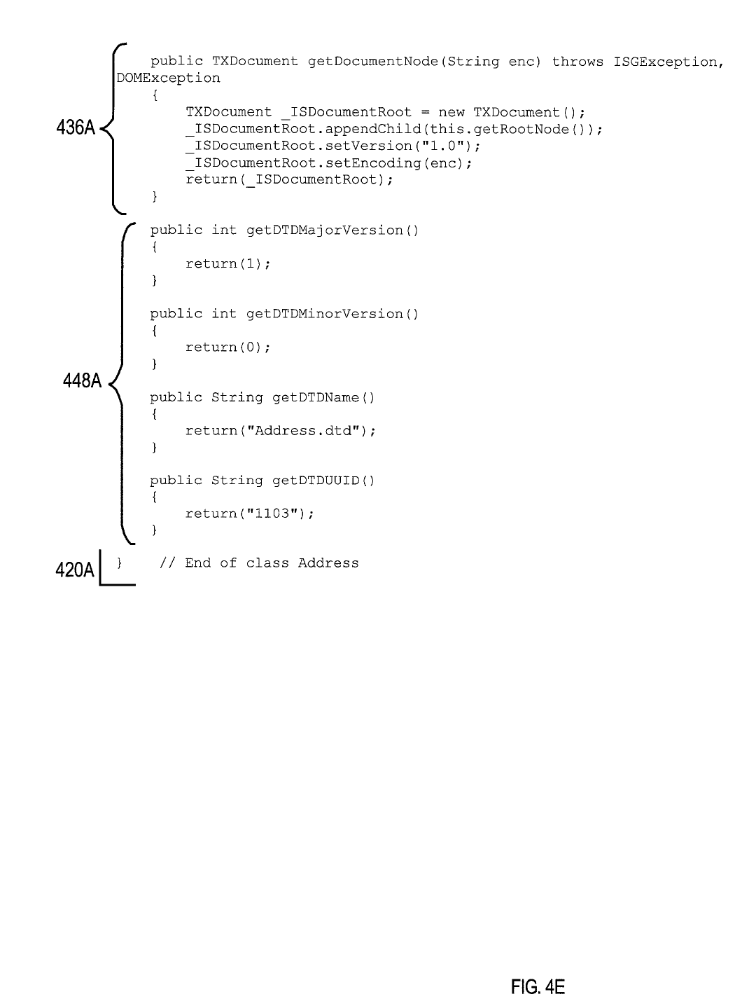

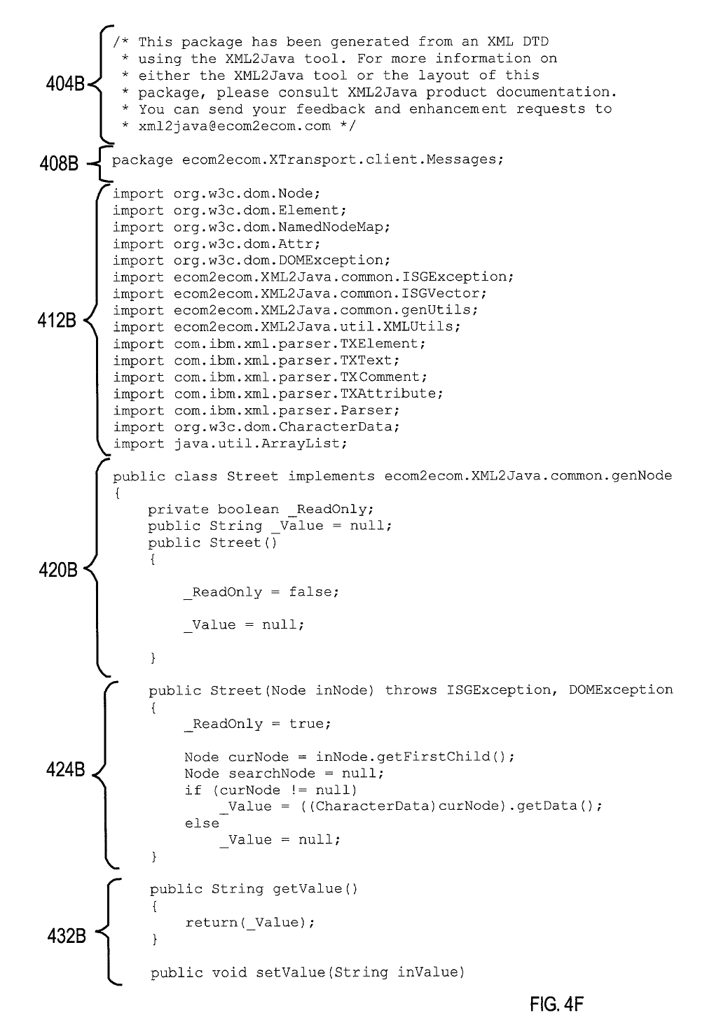

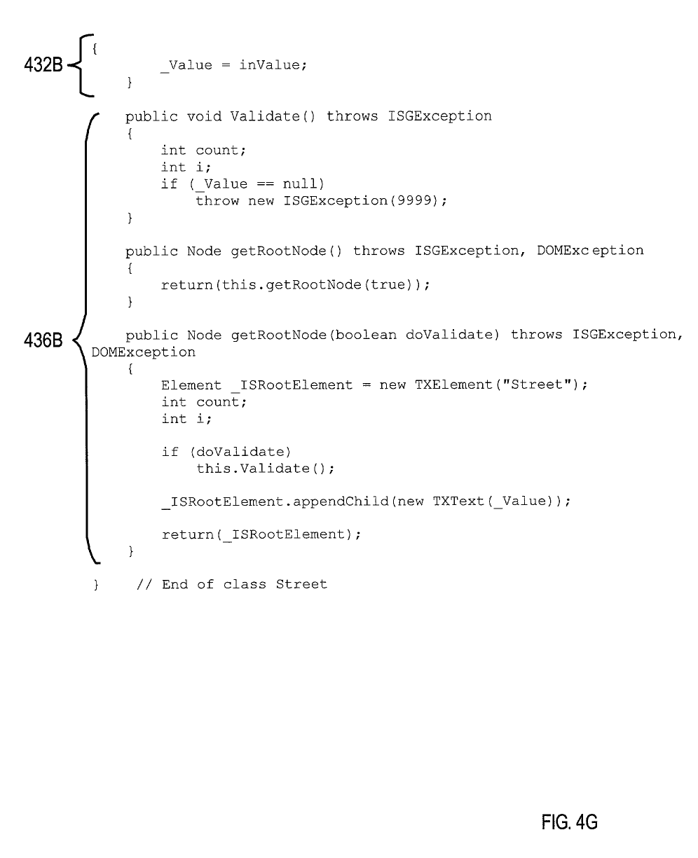

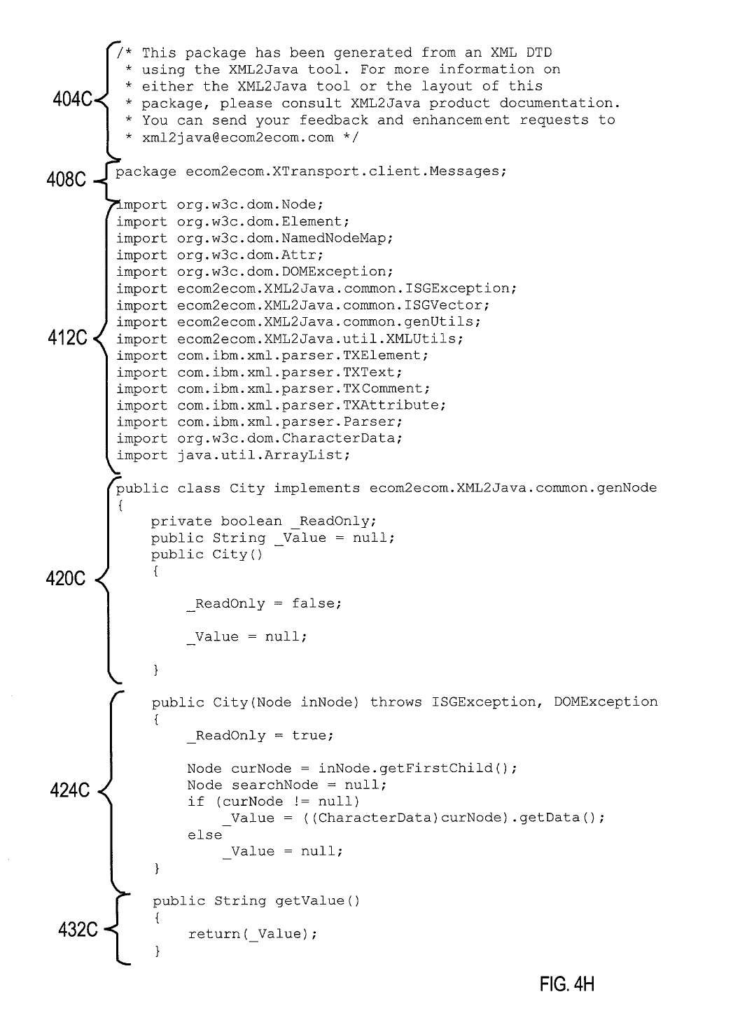

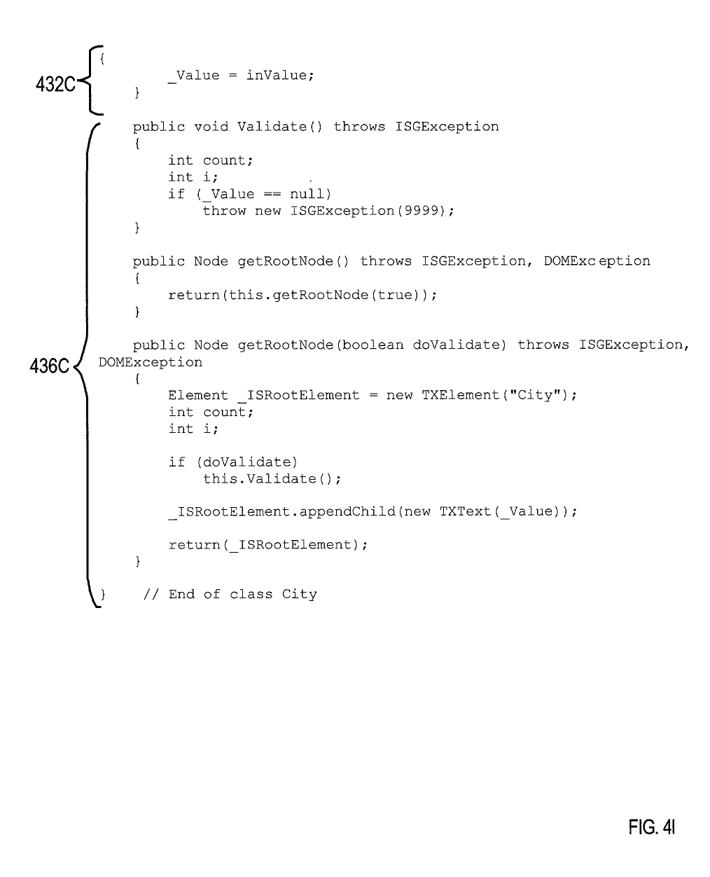

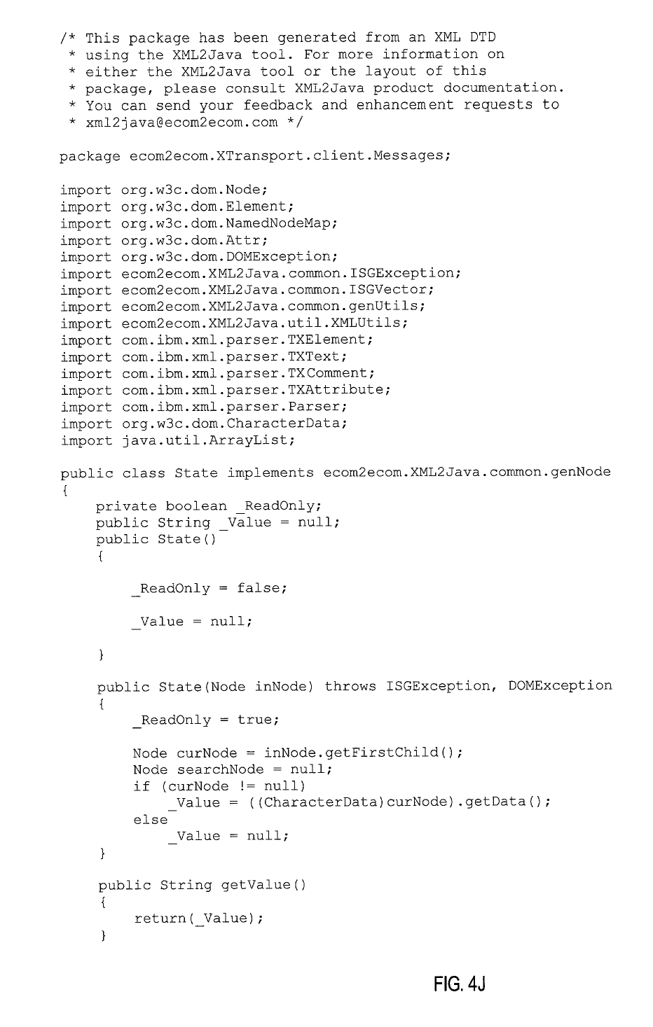

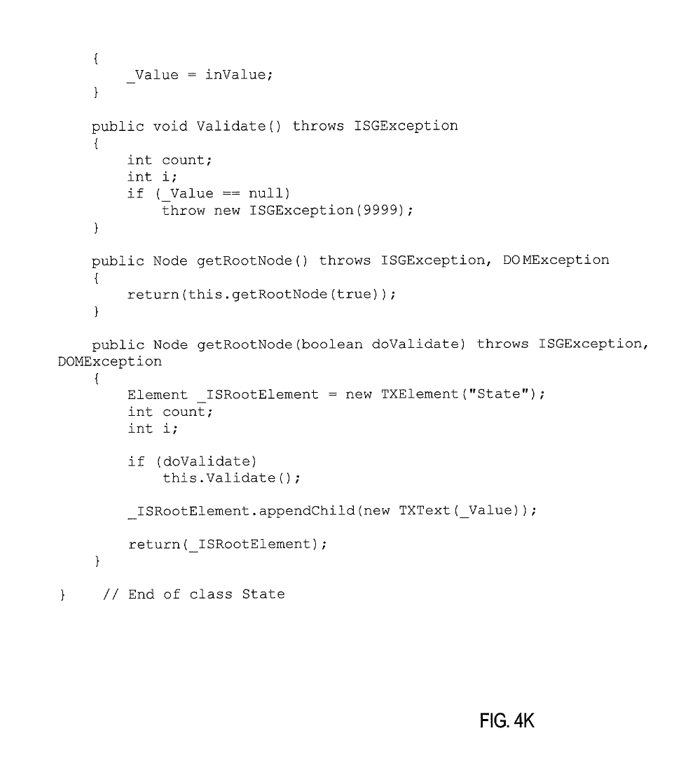

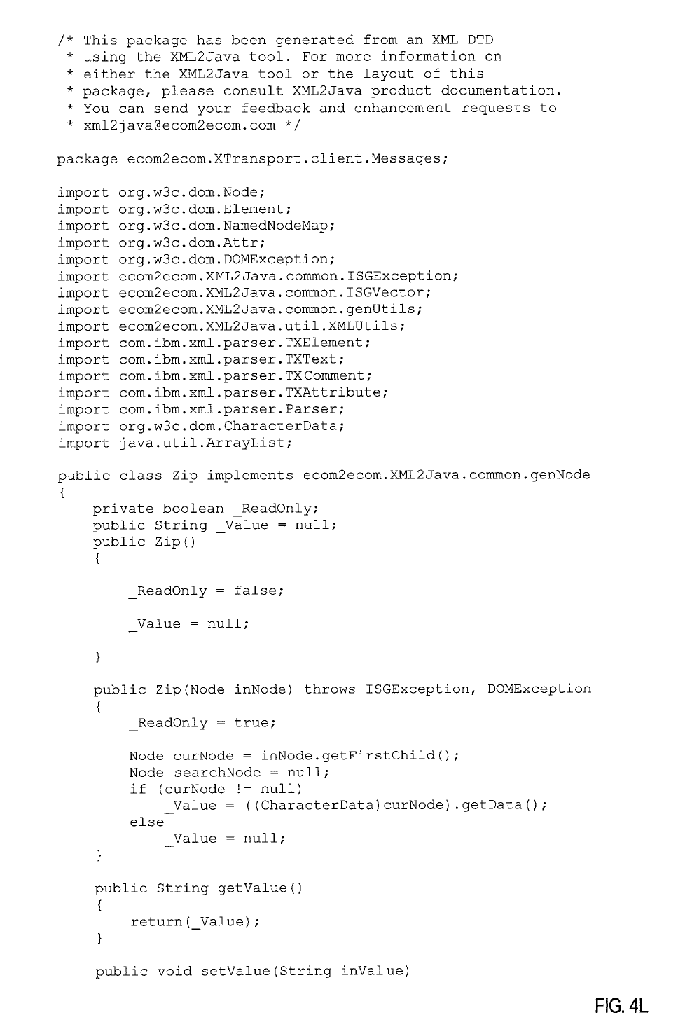

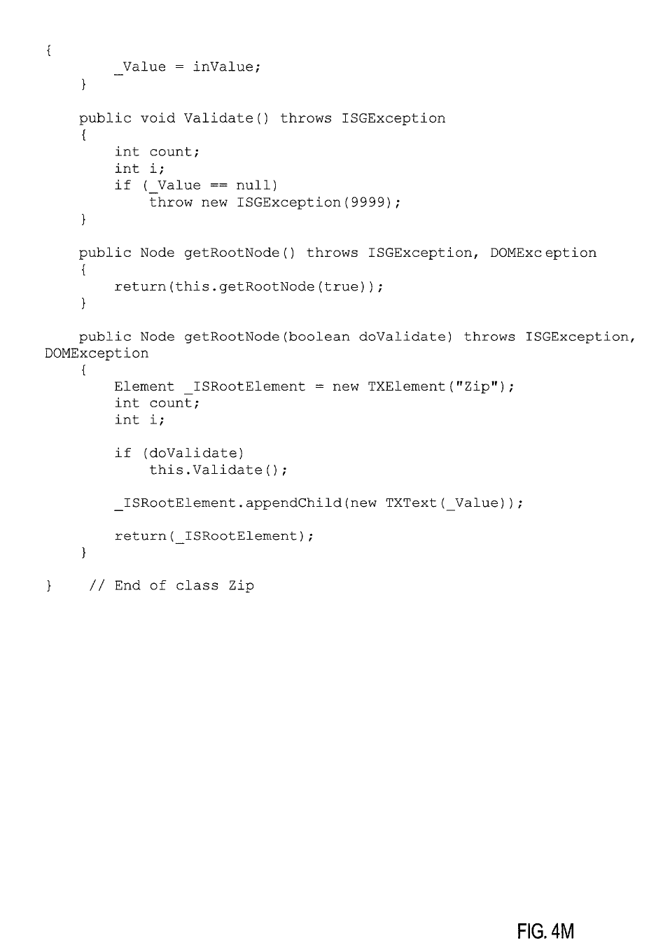

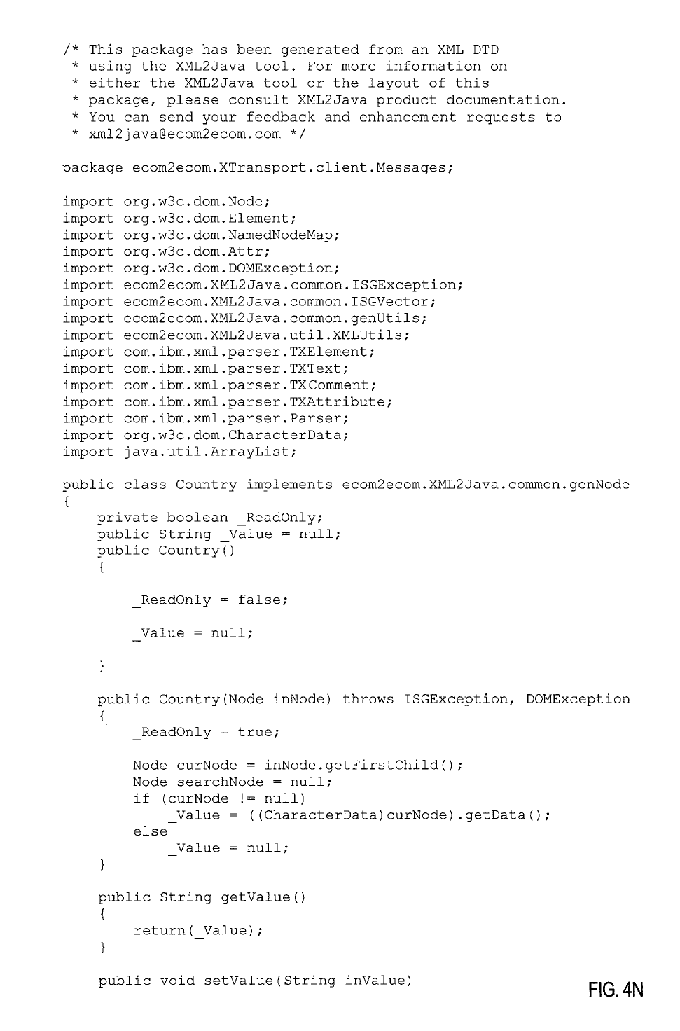

A translation tool is provided for generating classes, in an object oriented language, based on the XML DTD. FIGS. 4A to 4P show exemplary files 112, that may be produced by the translation tool based upon the XML DTD shown in FIG. 2. Each of the exemplary files 112 thus produced contains a respective Java class 110 that corresponds to each of the nodes Address, Street, City, State, Zip, and Country in FIG. 2. Each of the files 112 includes various sections having the same number except for the suffix A, B, C, etc. FIGS. 4A-4E are herein explained as an example. In FIG. 4A, section 404A includes comments. Section 408A is a package statement, which is a required statement in the Java language.

Section 412A shows the standard Java “import statements,” which are used to interface with other files in the Java programming library. In this example, because Address is a top-level node in FIG. 2, FIG. 4A includes section 416A, which shows the import statements for a top-level node. Each of the FIGS. 4F-4P that corresponds to child nodes Street, City, State, Zip, and Country, does not comprise a section 416.

Sections 420A, 422A, 424A, and 428A are the Java codes for various constructors. Section 420A is the code for the Address ( ) constructor. Section 424A is the code for Address(node) constructor and section 428A is the code for Address(InputStream) constructor. These constructors Address( ), Address(node), and Address(Input Stream) allow flexibility in accessing data objects in the Java classes. The Address( ) constructor allows XML_to_Java translation tool 108 to recreate XML document 102 from an instantiated Java object 124. In one embodiment, the instantiated Java object 124 recursively calls this Address( ) constructor to re-generate the XML document 102. The Address(node) constructor, being able to be called recursively, is used to generate the Java class files 112 for each of the classes 110. This Address(node) constructor accepts an argument of type node that specifies the node for which a class is created, e.g., node Street, City, etc. The Address(InputStream) constructor accepts an InputStream argument inStream that defines the name of XML document 102 to instantiate as Java object 124. Address(InputStream) constructor is used for the top-level node, e.g., node Address in FIG. 2. Those skilled in the art will recognize that InputStream could be of various type, including, for example, a string type.

Section 432A is the code for accessor methods that are used to access the Java classes and individual node attributes. For example, the “get” and “set” accessor methods (e.g., getStreet( ), setStreet( ), getCity( ), setCity( ), etc.) are created to provide a programmatic interface to the class.

Sections 436A is the code for various exceptions used in good programming practices. Exceptions are special programming procedure/subroutines designed to handle miscellaneous functions. For example, the exceptions check that the values of each of the node Address, City, State, etc., are valid.

Section 448A shows the common functions that are the Java class methods that retrieve information about the overall message as defined by the XML DTD 104. For example, these functions may retrieve the DTD version (getDTDMajorVersion( ), DTD identification (getDTDUUID( ) or retrieve information about the top-level Address node, which is especially helpful if the node in conversion is a root node.

The explanation for each section in FIGS. 4F-4P is the same for the corresponding section in FIGS. 4A-4E.

### METHOD STEPS IN CONVERTING AN XML DOCUMENT TO A JAVA OBJECT

FIG. 5 is a flowchart illustrating a method for converting an XML document 102, such as that shown in FIG. 3, to a Java object 124. For the purpose of explanation, it shall be assumed that XML document 102 contains an XML Address, as defined by the DTD illustrated in FIG. 2.

In step 504, XML_to_Java translation tool 108 uses a parser to parse the content of XML DTD 104 in FIG. 2, thus identifying the nodes Address, Street, City, State, Zip, and Country.

In step 508, XML_to_Java translation tool 108 converts each of the nodes Address, Street, City, State, Zip, and Country identified in step 504 to a respective Java class 110 Address, Street, City, State, Zip, and Country. XML_to_Java translation tool 108 stores each of these classes 110 to a respective file 112 in FIG. 4A to FIG. 4P.

In step 512, typically, a software engineer compiles files 112 to bytecode, which is then integrated into an executable Java program. The Java program produced by compiling the Java files 112 is able to populate an object using the XML document 102 in FIG. 3 as input.

In step 516, the software engineer runs the executable Java program in which a Java object 124 is instantiated from the class Address 110 and populated from the XML document 102. For example, the software engineer, in the Java language domain, writes:

Address a; wherein a is a Java object instantiated from the Java class Address

In step 520, the software engineer uses the Java object a as using any object in the Java language domain. Setting the data in FIG. 3, via object a, may be done as follows:

a.Address=“1288 Pear Ave.”;

a.City=“Mountain View”;

a.State=“CA”;

etc.

### METHOD STEPS FOR CREATING A JAVA CLASS CORRESPONDING TO AN XML

### DTD NODE

FIG. 6 is a flowchart illustrating the method steps in which XML_to_Java translation tool 108 creates the Java classes 110, in accordance with step 508 in FIG. 5. In this FIG. 6 example, the Address Java class is generated as an example, but those skilled in the art will recognize that other classes Street, City, State, etc. may be generated by using this flowchart.

In step 612 XML_to_Java translation tool 108 writes the package statement in section 408A.

In step 616, XML_to_Java translation tool 108 generates the standard import statements in section 412A.

In step 620, XML_to_Java translation tool 108 determines whether the node in conversion is the top-level node. If the node in conversion is a top-level node, then XML_to_Java translation tool 108 in step 624, in addition to the import statements generated in step 616, generates the top-level-node import statements in section 416A.

In step 628, XML_to_Java translation tool 108 generates the Java class declaration of section 420A.

In step 632, XML_to_Java translation tool 108 generates the Java class attribute variables of section 422A. XML_to_Java translation tool 108 uses each of the classes for a child node (e.g., Street, City, State, etc.) as a corresponding class attribute.

In step 636, XML_to_Java translation tool 108 generates constructors of sections 424A and 428A.

In step 637, XML_to_Java translation tool 108 determines whether the node in conversion is a top-level node. If the node in conversion is a top-level node, then XML_to_Java translation tool 108 in step 638 generates an InputStream constructor. Because the Address node is a top-level node, XML_to_Java translation tool 108 adds the Address(InputStream) constructor (section 428A).

In step 640, XML_to_Java translation tool 108 creates the accessor methods in section 432A.

In step 642, XML_to_Java translation tool 108 creates the Java validation method (section 436A).

In step 644, XML_to_Java translation tool 108 creates the Java-to-DOM converter method (the getRootNode( ) method of section 438A).

In step 648, XML_to_Java translation tool 108 generates the common functions in section 448A.

During the conversion process, XML_to_Java translation tool 108, when appropriate, adds comments (e.g., sections 408A) and syntaxes (e.g., open and close brackets) to conform to the Java language domain.

### HARDWARE OVERVIEW

FIG. 7 is a block diagram that illustrates a computer system 700 upon which an embodiment of the invention may be implemented. In particular, computer system 700 may be configured to run XML_to_Java translation tool 108 or other programs discussed above. Computer system 700 includes a bus 702 or other communication mechanism for communicating information, and a processor 704 coupled with bus 702 for processing information. Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Computer system 700 further includes a read only memory (ROM) 708 or other static storage device coupled to bus 702 for storing static information and instructions for processor 704. A storage device 710, such as a magnetic disk or optical disk, is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

The invention is related to the use of computer system 700 for implementing the techniques described herein. According to one embodiment of the invention, those techniques are implemented by computer system 700 in response to processor 704 executing one or more sequences of one or more instructions contained in main memory 706. Such instructions may be read into main memory 706 from another computer-readable medium, such as storage device 710. Execution of the sequences of instructions contained in main memory 706 causes processor 704 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 704 for execution. Such a medium may take many forms, including but not limited to, non-volatile media, volatile media, and transmission media. Non-volatile media includes, for example, optical or magnetic disks, such as storage device 710. Volatile media includes dynamic memory, such as main memory 706. Transmission media includes coaxial cables, copper wire and fiber optics, including the wires that comprise bus 702. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 704 for execution. For example, the instructions may initially be carried on a magnetic disk of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are exemplary forms of carrier waves transporting the information.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718. In accordance with the invention, one such downloaded application implements the techniques described herein.

The received code may be executed by processor 704 as it is received, and/or stored in storage device 710, or other non-volatile storage for later execution. In this manner, computer system 700 may obtain application code in the form of a carrier wave.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded as illustrative rather than as restrictive.

What is claimed is:

1. A method for facilitating access to data stored in an XML documents, comprising the steps of:
identifying data nodes in an XML document type definition file;
for each data node of a set of data nodes identified in said XML document type definition file, automatically generating class definition data that defines a corresponding class in an object-oriented programming language;
wherein the step of automatically generating class definition data includes automatically generating data that defines a particular class that corresponds a particular data node in said XML document type definition file;
wherein said particular data node encompasses all other data nodes in said set of data nodes; and
wherein said particular class includes properties for storing data associated with all other data nodes in said set of data nodes.

2. The method of claim 1 further including the steps of:
instantiating objects based on said particular class; and
populating at least some of the properties of said objects from data contained in XML documents that are structured as specified in said XML document type definition file.

3. The method of claim 1 wherein:
the object-oriented programming language is Java; and
the step of automatically generating class definition data includes generating one or more Java class files.

4. The method of claim 1 wherein:
the set of data nodes includes all data nodes in said XML document type definition file; and
the step of automatically generating class definition data that defines a corresponding class in an object-oriented programming language includes automatically generating class definition data that defines a class for all data nodes in said XML document type definition file.

5. The method of claim 2 further including the step of accessing data contained in said XML documents by calling methods of objects that have been instantiated from said particular class and populated from data in said XML documents.

6. The method of claim 1 wherein the step of automatically generating class definition data that defines a corresponding class includes the steps of:
establishing a data node within said XML document type definition file as a current data node;
determining whether the current data node is a top-level node;
if the current data node is a top-level node, then generating said corresponding class to include top-level node import statements; and
if the current data node is not a top-level node, then generating said corresponding class to without top-level node import statements.

7. The method of claim 1 wherein the step of automatically generating class definition data that defines a corresponding class includes the steps of:
establishing a data node within said XML document type definition file as a current data node;
determining whether the current data node is a top-level node;
if the current data node is a top-level node, then generating said corresponding class to include an input stream constructor; and
if the current data node is not a top-level node, then generating said corresponding class to without an input stream constructor.

8. The method of claim 3 wherein the step of automatically generating class definition data that defines a corresponding class includes the steps of:
generating standard import statements;
generating a Java class declaration;
generating Java class attribute variables;
generating Java class constructors;
generating Java accessor methods; and
generating Java common functions.

9. A computer-readable medium bearing instructions for facilitating access to data stored in XML documents, said instructions comprising instructions for performing the steps of:
identifying data nodes in an XML document type definition file;
for each data node of a set of data nodes identified in said XML document type definition file, automatically generating class definition data that defines a corresponding class in an object-oriented programming language;
wherein the step of automatically generating class definition data includes automatically generating data that defines a particular class that corresponds a particular data node in said XML document type definition file;
wherein said particular data node encompasses all other data nodes in said set of data nodes; and
wherein said particular class includes properties for storing data associated with all other data nodes in said set of data nodes.

10. The computer-readable medium of claim 9 further including instructions for performing the steps of:
instantiating objects based on said particular class; and
populating at least some of the properties of said objects from data contained in XML documents that are structured as specified in said XML document type definition file.

11. The computer-readable medium of claim 9 wherein:
the object-oriented programming language is Java; and
the step of automatically generating class definition data includes generating one or more Java class files.

12. The computer-readable medium of claim 9 wherein:
the set of data nodes includes all data nodes in said XML document type definition file; and
the step of automatically generating class definition data that defines a corresponding class in an object-oriented programming language includes automatically generating class definition data that defines a class for all data nodes in said XML document type definition file.

13. The computer-readable medium of claim 10 further including instructions for performing the step of accessing data contained in said XML documents by calling methods of objects that have been instantiated from said particular class and populated from data in said XML documents.

14. The computer-readable medium of claim 9 wherein the step of automatically generating class definition data that defines a corresponding class includes the steps of:
establishing a data node within said XML document type definition file as a current data node;
determining whether the current data node is a top-level node;
if the current data node is a top-level node, then generating said corresponding class to include top-level node import statements; and
if the current data node is not a top-level node, then generating said corresponding class to without top-level node import statements.

15. The computer-readable medium of claim 9 wherein the step of automatically generating class definition data that defines a corresponding class includes the steps of:
establishing a data node within said XML document type definition file as a current data node;
determining whether the current data node is a top-level node;
if the current data node is a top-level node, then generating said corresponding class to include an input stream constructor; and
if the current data node is not a top-level node, then generating said corresponding class to without an input stream constructor.

16. The computer-readable medium of claim 11 wherein the step of automatically generating class definition data that defines a corresponding class includes the steps of:
generating standard import statements;
generating a Java class declaration;
generating Java class attribute variables;
generating Java class constructors;
generating Java accessor methods; and
generating Java common functions.
